(19) United States
(12) Patent Application Publication
(10) Pub. No.: US 2009/0303338 A1
(43) Pub. Date: Dec. 10, 2009

(54) DETAILED DISPLAY OF PORTION OF INTEREST OF AREAS REPRESENTED BY IMAGE FRAMES OF A VIDEO SIGNAL

(75) Inventors: Parag Chaurasia, Mumbai (IN); Narendran Melethil Rajan, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/406,956

(22) Filed: Mar. 18, 2009

(30) Foreign Application Priority Data
Jun. 6, 2008 (IN) 1383/CHE/2008

(51) Int. Cl. H04N 5/228; H04N 9/64; H04N 7/01; H04N 9/74

(52) U.S. Cl. 348/222.1; 348/720; 348/441; 348/584; 348/E09.037; 348/E05.031; 348/E07.003; 348/E09.055

(57) ABSTRACT

According to an aspect of the present invention, a sequence of combined frames are formed by including each of a sequence of source image frames and a portion of the same source image frame in the corresponding combined frame. The combined image frames may be displayed on a display screen. The display screen can also be used to display the sequence of source image frames alone (instead of the combined image frames), at user's option.

### RELATED APPLICATION(S)

The present application claims the benefit of co-pending India provisional application serial number: 1383/CHE/2008, entitled: “New approach to digital video visualization on embedded devices by a novel region-selective zooming mechanism”, filed on 6 Jun. 2008, naming the same inventors as in the subject application, attorney docket number: TXN-949, and is incorporated in its entirety herewith.

### BACKGROUND

1. Field of Disclosure

The present disclosure relates generally to display technologies, and more specifically to detailed display of portion of interest of areas represented by image frames of a video signal.

2. Related Art

A video signal generally contains a sequence of image frames, as is well known in the relevant arts. The image frames represent respective scenes of interest captured by devices such as video cameras.

In the case of video cameras, a user points a video camera to an area/scene and causes the video camera to capture the scene represented by the pointed area, to form a video signal. The area contains objects (which are physical in nature and reflect light) of interest, and scenes representing the objects are captured by the video camera.

In general, it may be required that the image frames (or scenes represented by the image frames) of a video signal be displayed as suited for specific users.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

According to an aspect of the present invention, a sequence of combined frames are formed by including each of a sequence of source image frames and a part (i.e., not the entire image frame) of the same source image frame in the corresponding combined frame. When the combined frames are displayed, users (viewers) may have both a complete view of a scene captured by each source image frame, and yet have a detailed view of the specific part of interest.

According to another aspect of the invention, the part (sub-area) of interest to the user is displayed at higher resolution compared to the entire source image frame, included in the combined image frames. The combined image frames may be displayed in the display area, which may also be used to display the entire source image frame without combining with other source image frames. Thus, when displayed alone (i.e., without combining), the scenes (represented by the source image frames) are displayed in the display area with lower resolution than a part of interest which would be displayed in the combined image frames

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### BRIEF DESCRIPTION OF THE VIEWS OF DRAWINGS

Example embodiments will be described with reference to the following accompanying drawings, which are described briefly below.

FIG. 1 is a block diagram of an example environment in which several aspects of the present invention can be implemented.

FIG. 2 is a flowchart illustrating the manner in which a portion of interest of an area represented by each of the image frames of a video signal is displayed in an embodiment of the present invention.

FIG. 3A is a diagram used to illustrate an example image frame received from a source.

FIG. 3B is a diagram used to illustrate the manner in which an image frame from a source may be rendered in a display area.

FIG. 3C is a diagram used to depict the manner in which an image frame is rendered on a display unit in an embodiment of the present invention.

FIGS. 3D-31 are diagrams depicting additional examples of image frames rendered on a display unit in respective embodiments.

FIG. 4 is a block diagram used to illustrate the details of a processing unit in an embodiment of the present invention.

FIG. 5 is a diagram used to illustrate an example image frame in an embodiment.

FIG. 6 is a block diagram illustrating the details of a digital processing system in which various features of the present invention are operative upon execution of an executable module.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Various embodiments are described below with several examples for illustration.

1. Example Environment

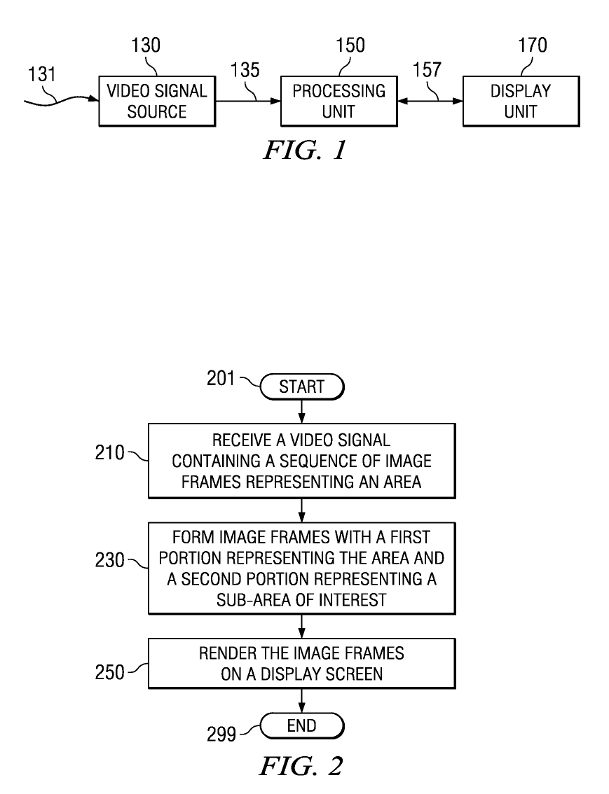

FIG. 1 is a block diagram illustrating an example environment in which several features of the present invention may be implemented. The example environment is shown containing only representative systems for illustration. However, real-world environments may contain many more systems/components as will be apparent to one skilled in the relevant arts by reading the disclosure provided herein. Implementations in such environments are also contemplated to be within the scope and spirit of various aspects of the present invention.

The diagram is shown containing video signal source 130, processing unit 150 and display unit 170. Each block is implemented with corresponding hardware components (e.g., circuits, printed circuit boards, etc.), with the support of any executable modules, as suited in the specific environments. In an embodiment, the three blocks are contained in a mobile phone, with small display area. The user may accordingly wish to view a portion of the image frames in greater detail and various aspects of the present invention facilitate convenient display of such portions in the sequence of image frames, as described below.

Video signal source 130 (for example video camera) provides sequences of image frames in the form of a video signal. For example, a video camera captures a scene (a general area sought to be captured) received in the form of light 131 and provides the resulting sequence of captured image frames on path 135. The image frames captured (generally in an uncompressed format) by video signal source 130 may be in any of the formats such as RGB, YUV, etc., as is well known in the relevant arts. Each image frame contains a set of pixel values representing the captured scene when viewed as a two-dimensional area in a coordinate space. Each captured scene contains physical objects, as noted above.

Display unit 170 displays the sequence of image frames on a viewing or display area (on a display screen). It may be appreciated that the term “displaying image frames” is used to mean displaying of the scenes represented by the image frames, as will be clear from the context. The display areas are generally of rectangular shape (square being an instance of the rectangle), though alternative embodiments can be implemented with other shapes for the display area. In an embodiment, display unit may be implemented using technologies such as LCD (Liquid Crystal display), TFT (Thin Film Transistor), etc.

Processing unit 150 processes the image frames received on path 135 (to transform these image frames, representing the objects in the captured scenes) to form image frames for display on display unit 170. The image frames are generated to provide greater detail of specific sub-area of each image frame, as described below in further detail with examples. Display signals, consistent with the implementation of display unit 170, may be generated

For example, with respect to mobile phones having a small display area, the image frames may be received on path 135 with a higher resolution (e.g., as a 704×576), but the displayed image frame on display unit 170 may be displayed with lower resolution or detail (e.g., 320×240), due to the limited display area available on display unit 170. The user may wish to view specific portion of the frames in greater detail. For example, a user may wish to view in greater detail, ¼ of the each of the frames on path 135.

The manner in which image frames are generated for display according to several aspects of the present invention, is described below with examples.

2. Displaying Sequence of Image Frames

FIG. 2 is a flowchart illustrating the manner in which a portion of interest of an area represented by each of the image frames of a video signal is displayed in an embodiment of the present invention. The flowchart is described with respect to FIG. 1, merely for illustration. However, various features can be implemented in other environments and other components.

Further, the steps are described in a specific sequence merely for illustration. Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, processing unit 150 receives a video signal containing a sequence of image frames sought to be displayed on display unit 170. Each frame is characterized by an area in two dimensional space. While the video signal is described as being generated/captured by video signal source 130, in an alternative embodiment, the video signal may be received from a memory unit (for example, provided in an external computer, not shown), which has earlier stored the image frames (either from some other source, or after the image frames were generated by a camera) or from an external source (e.g., on a network). In general each video signal contains a sequence of image frames, with each frame containing a set of pixels represented in an area of a 2 dimensional space.

In step 230, processing unit 150 forms image frames with a first portion representing the (entire) area (of the image frame) and a second portion representing a sub-area (sub-image/part) of interest of the same frame. Thus, the first portion would represent the entire image frame, while the second portion would represent a part of the image frame (or sub-area of the area represented by the image frame). The display area on display screen 170 can thus be used (in a desired way) to accommodate both the portions.

In step 250, processing unit 150 renders the formed image frames on a display screen in the display unit 170. Rendering the formed image frame entails generating/sending appropriate display signals (e.g., RGB signals to refresh the display screen) that cause the image frame containing the first portion (representing the entire area of the frame) and the second portion (representing the area of interest or sub-area of the frame) to be displayed on display unit 170. The method ends in step 299.

Thus, assuming that image frames are received at 30 frames per second, the corresponding formed frames may also be rendered at the same rate. By providing the ability to view such formed image frames, various advantages may be realized in corresponding environments. The advantages in an embodiment of a mobile phone with small display screens, is illustrated below, with an example.

3. Display of Image Frames

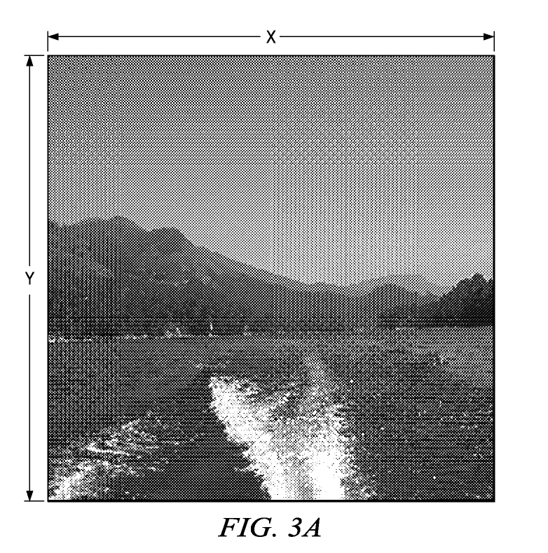

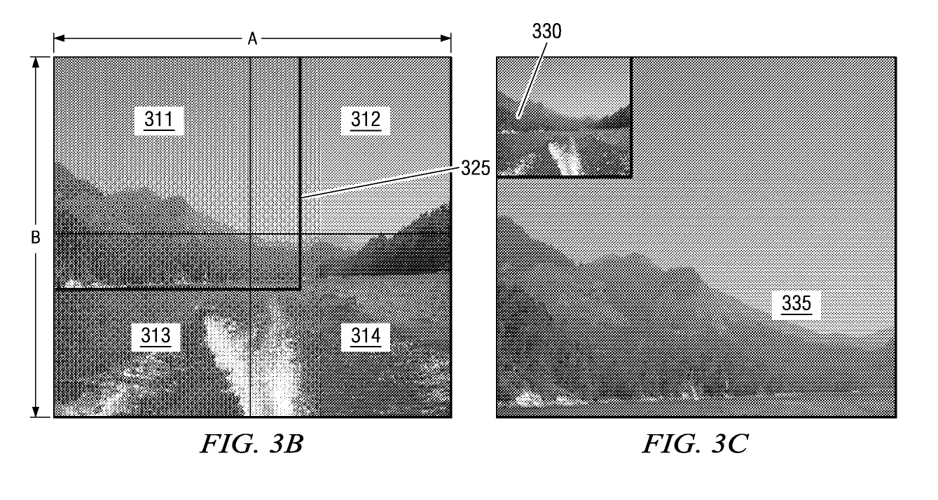

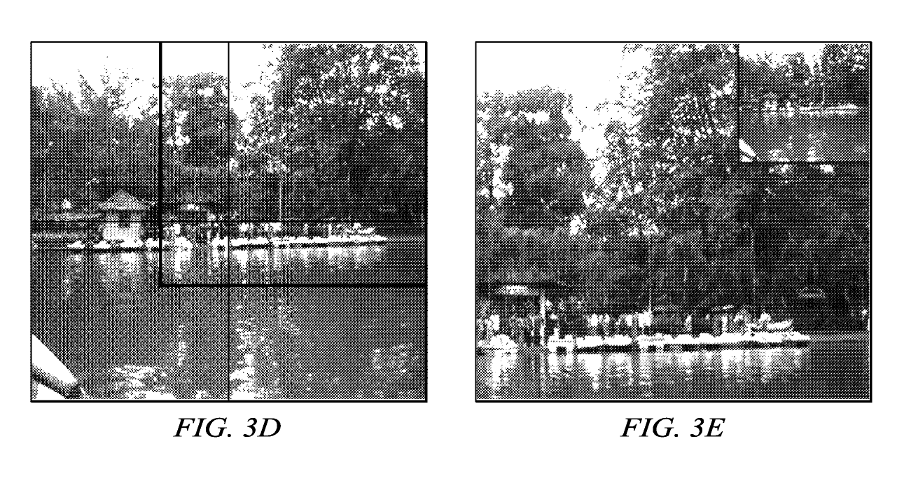

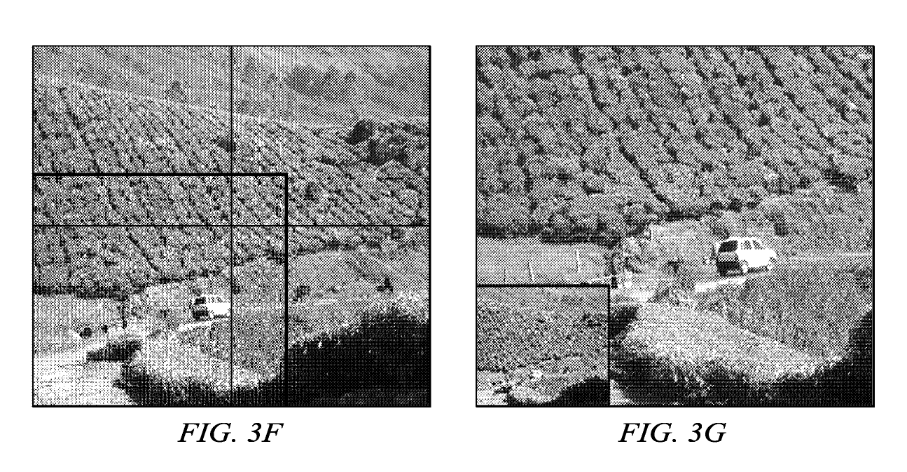

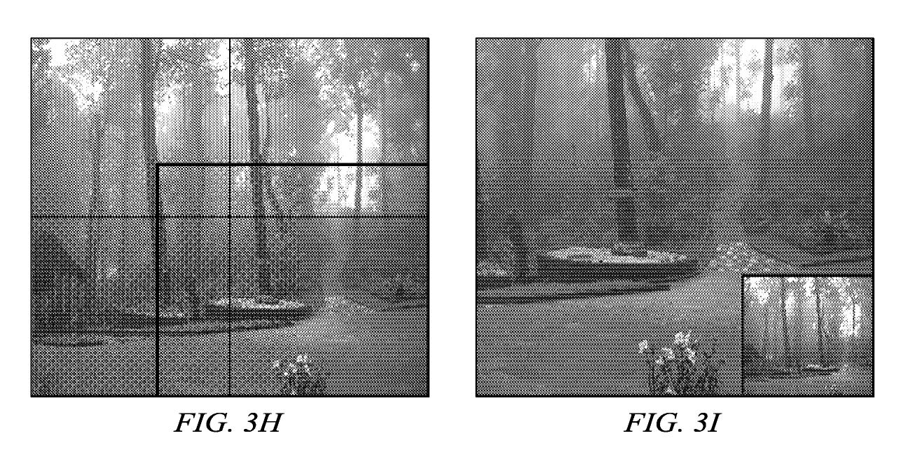

The user experience in an embodiment is illustrated with combined reference to FIGS. 3A-3C. FIG. 3A depicts a scene in a received image frame. For ease of illustration, it is assumed that the scene is not changing and thus the sequence of image frames represent the same scene. Each of the image frames may be logically viewed as spanning a same area identified by corresponding coordinates of the two dimensional coordinate space.

FIG. 3B depicts the corresponding display on a display area provided on a display screen of display unit 170. It may be appreciated that the size of the displayed image frame (A×B units) may be different than the size of the received image frame (X×Y) and accordingly FIG. 3B is shown with a smaller size compared to the image frame in FIG. 3A. Thus, a 704×576 image frame is displayed on a display area with dimensions/pixels 320×240.

The display area is logically divided into four quadrants (or in general, region of any suitable size/shape, etc.) defined by points 311-314, merely to enable a user to specify one of the quadrants (or corresponding sub-area of the image frame) as being of interest. Assuming the display area is also a touch screen, the user may touch one of the quadrants 311-314, to select the sub-area of interest. Alternatively, combinations of key-boards and pointing devices, may be used to select the sub-area of interest.

It is now assumed that the user selects a location in quadrant 311, thereby indicating interest to view the selected (top-left) part in greater detail. The display generated as a result, is the portion/sub-image 335 shown in FIG. 3C. It may be appreciated that when user selects quadrant 311, a bigger portion (shown with line 325 as the boundary) than the quadrant itself (at least two third of the area/size of the image frame) may be selected in one embodiment as shown in FIG. 3B (and also FIGS. 3D,3F and 3H).

FIG. 3C depicts a combined image frame containing two portions 330 and 335. Portion 335 spans the entire display area excluding area 330. Portion 330 contains (a downscaled version of) the entire image frame (of FIG. 3B), while portion 335 displays the selected sub-area 325 in greater detail. In this example, top left portion of image frame (area 325 of FIG. 3B) is zoomed in by 50% to cover the display area (FIG. 3C, with area 330 excluded) thus forming the sub-image.

The greater detail in portion 335 (compared to that in portion 325 of FIG. 3B) is based on the enhanced information present in source image frame of FIG. 3A. Thus, as the source image frames are generated with greater resolutions, some of the detail that may be lost on smaller display screens, can be viewed by using the higher resolution display in portion 335.

Again, though shown as a static image frame in FIG. 3C, it should be appreciated that the image frame on display screen/area are continuously updated based on each of the sequence of image frames received in the video signal.

In particular, each image frame is processed and rendered according to the flow chart of FIG. 2. However, the specific sub-area selected for each of the frames is deemed to be the same, until the selected sub-area is changed by the user (using the display in portion 330) or dynamically (for example, to track an object, as described in sections below).

It should be appreciated that portion 330 can be located in any of several positions within the display area. In an embodiment, portion 330 is placed in that corner of the quadrant in which completely lies the area of interest (selected by the user). Thus, since the area of interest selected by the user is top left portion of FIG. 3B (and accordingly the enlarged display of that portion is shown in portion 335 of FIG. 3C), portion 330 containing the display of the entire image frame is shown located in the top left corner. Alternatively, area 330 may be located in the diagonally opposite corner to ensure the top left corner of the portion of interest is not hidden (not displayed) due to area 330.

It should be further appreciated that resolution of display in portion 330 is least (since the entire image frame is shown compressed into a small portion of the display area), while that in area 335 is most since a small sub-area of the image frame is shown enlarged there. The resolution in FIG. 3B would be in between the least and most resolutions of FIG. 3C since the entire display is generated with the same resolution of the entire image frame.

Thus, a portion (325) of interest is zoomed and displayed in area 335, to cover a substantial part of the display screen. At the same time the entire image frame is shown in a smaller part of the display screen, at a lower resolution.

Further it may be appreciated that a user can change the area of interest by choosing a different portion (different from the portion chosen above) using the downscaled version of the displayed image frame (portion 330 of FIG. 3C). Thus, when the user selects a new portion using the display in portion 330 (of FIG. 3C), the point is mapped to one of the four quadrants within sub-area 330 (of FIG. 3C), and the subsequent image frames are formed and rendered based on the selection (i.e., portion 335 would represent the newly selected sub-area and the location of portion 330 is also determined based on the selection). The downscaled version of full image frame serves as an input for the user to decide which region of the video sequence should be zoomed/emphasized next, for the upcoming frames (for a convenient or closer view of the distant object/details or high motion).

FIGS. 3D, 3F and 3H illustrate the sub areas selected, with each sub-area covering at least one of the quadrants fully and the corresponding display provided on a display screen of display unit 170 is illustrated in FIGS. 3E, 3G and 31 respectively. For example in FIG. 3D, a portion corresponding to the top right quadrant is selected as sub-area of interest and FIG. 3E (corresponding display of 3D) shows enlarged version (sub-image) of the selected portion while displaying a downscaled version of the entire image frame at top right corner. Similarly in FIG. 3F bottom left portion is selected as the area of interest and the portion is shown enlarged in FIG. 3G along with the entire image frame at the bottom left.

Due to such a display of the entire image frame in one portion and the sub-area of interest in another portion, the techniques may be more user friendly at least in some situations. The features described above (with various modifications, as well), can be implemented in several embodiments. Some example embodiments are described below in further detail.

4. Example Implementation

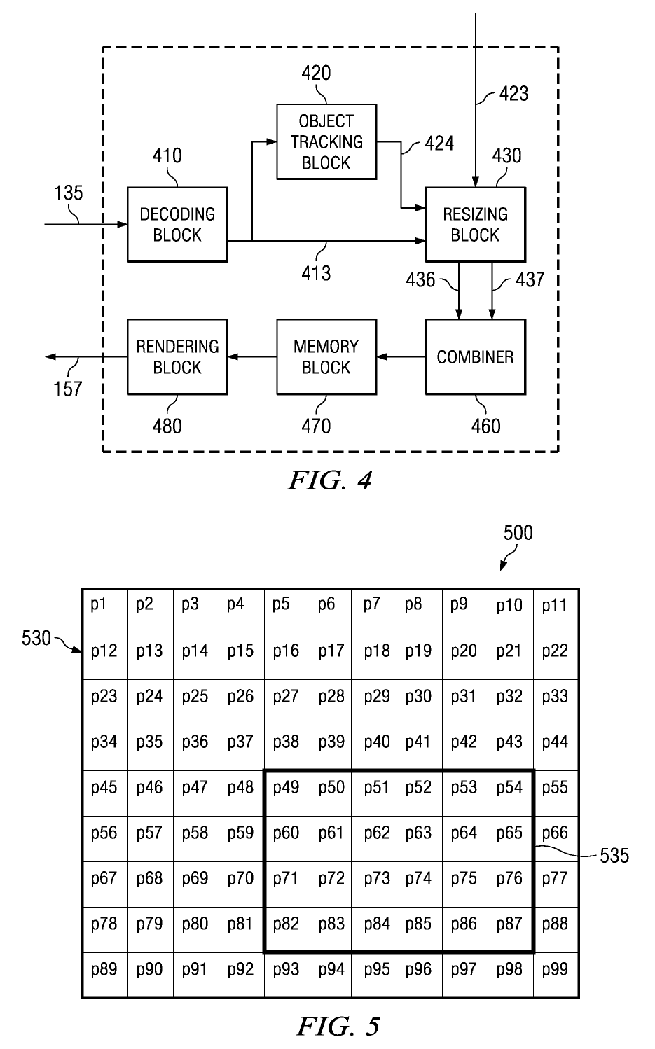

FIGS. 4 and 5 together illustrate the manner in which image frames for display are formed and rendered in one embodiment. The block diagram of FIG. 4 is shown containing decoding block 410, object tracking block 420, resizing block 430, combiner 460, memory block 470, and rendering block 480. Each block can be implemented as an appropriate hardware block, supported by any necessary executable modules and/or firmware. Though the blocks are shown separately, some of them can be combined or more blocks may be present depending on the environment of operation.

Decoding block 410 decodes the encoded frame data received via path 135, assuming that the image frames are encoded according to standards such as MPEG and H.264, when received on path 135. In general, decoding block 410 reconstructs the image frame from corresponding encoded/compressed data present in the video signal. The reconstructed image frame contains the corresponding data/pixels representing each of the sequence of image frames. Decoding block 410 then assembles the reconstructed data/pixels to generate a reconstructed image frame on path 413.

Resizing block 430 provides on path 436, a resized version of the entire image frame, to fit in the desired size of a display area. For example, when the displays are generated according to FIG. 3B, the resized image frame would span the entire display area of the display unit. The number of pixels in the resized image frame may thus equal the number of display points/pixels in the display screen. On the other hand, when the displays are generated according to FIG. 3C, the resized image frame (corresponding to the entire image frame) provided on path 436 would have the size equaling the area of portion 330.

Resizing block 430 further provides on path 437, a resized version of part of interest in each of the received image frames when the displays are generated according to FIG. 3C. The resized portion is generated with a higher resolution compared to portion 330 of FIG. 3C and the display of FIG. 3B. Higher resolution implies that more of the display area is used for displaying the same part/information of an image frame received on path 413 (or image frame part in general). Path 437 may not be used when displays are generated according to FIG. 3B.

The specific portion provided at higher resolution, may be identified based on user input 423 alone and/or determined by object tracking block 420. It may be appreciated that input 423 may be received from a user when the user touches the area of interest on the viewing area/screen of the display unit 170 indicating the touch point as the center of the pre defined rectangular area (sub-area) of selection.

For example, assuming that reconstructed image frame 500 is received on path 413 and that location identified by pixels p62, p63, p73 and p74 is selected by a user, resizing block 430 may decide to provide at higher resolution/detail, the image frame portion corresponding to sub-area shown as box 535. Such higher resolution image frame is displayed in portion 335 of FIG. 3C.

Object tracking block 420 identifies sub-areas to be provided in higher resolution based on an object in the scene selected by a user. The object in turn may be determined based on user specifying a location of interest (on path 423). For example, assuming that a user selects a location covering a slowly moving car (shown in FIG. 3F) in bottom left portion, object tracking block 420 may determine the car as being the object of interest.

Object tracking block 420 thereafter examines at least some of the succeeding image frames to determine the position of the car. The position may be determined based on various processing techniques well known in the relevant arts. Thus, the sub-area of interest corresponds to the locations where the car is deemed to be present in the sequence of image frames. The determined position is provided as an input to resizing block 430 via path 424, which then displays a corresponding portion in display area of FIG. 3G. Object tracking block 420 thus changes the sub-area of interest by examining the image frames.

Combiner 460 combines the image frames received on paths 436 and 437 to form a combined frame for rendering on display unit 170 when the displays are provided in accordance with FIG. 3C. Otherwise, the image frame received on path 436 is passed as the combined frame. The image frame thus formed is stored in memory block 470. In an embodiment, the combining operation is performed by placing the image frame on path 436 (downscaled version of entire image frame) over the image frame received on path 437 (portion/part of interest).

The specific area where the entire image frame is to be placed is determined by combiner, for example, as described above. Briefly, combiner 460 divides the display area (or portion of interest) into 4 quadrants (top left, bottom left, top right and bottom right) and depending upon in which quadrant most of the sub-area is located, combiner 460 chooses that quadrant for placing the resized output 436. For example in the image frame shown in FIG. 5, the input 423 is in the bottom right portion and thus the combiner 460 places the entire image frame 436 in the bottom right corner.

Rendering block 480 generates display signals on path 157 based on the pixel values present in memory block 470 to cause the stored image frames to be displayed on a display screen provided by display unit 170.

Thus, both the downscaled version of the entire image frame and the sub-area/part of interest (535) at higher resolution (forming the sub-image), are displayed on the display unit 170 as a single frame. As a result, the specific portion of interest may be viewed in greater detail, while the entire image frame provides a global view of the scene, in addition to facilitating manual selection of a different sub-area/part of interest for the upcoming image frames. Thus, the feature operates to provide the user to have a convenient/closer view of the subject/object of interest especially for video sequences containing distant object/details or when the object is continuously moving.

While the features above are described substantially with respect to a mobile phone having a small display area, it should be appreciated that at least some of the features can be implemented in other environments as well. For example, the features can be implemented in other devices (e.g., embedded devices with limited resources) having small display area. In general, the devices which display image frames as described above, are referred to as display devices. It should be appreciated that the display devices can receive the source image frames from external sources (e.g., streamed from the Internet) or can be generated internally (in which case the display device is a video camera).

As another example, the above described techniques can be used for broadcast and live streaming applications. As an illustration, assuming a baseball game is being broadcast, the entire field can be shown as the entire image frame (of FIG. 3B) and then an operator at the broadcast may select an area as the sub-area of interest. The combined frames formed in accordance with FIGS. 3C/3E/3G/31 may then be broadcast for display at various television systems. Such a display is desirable when the user may not have the option to rewind and view the past scenes again, or to pause and see the scene details.

Various aspects of the present invention can be implemented in a desired combination of hardware, executable modules and firmware. The description is continued with respect to an embodiment in which the features are operative upon execution of the executable modules.

5. Software Implementation

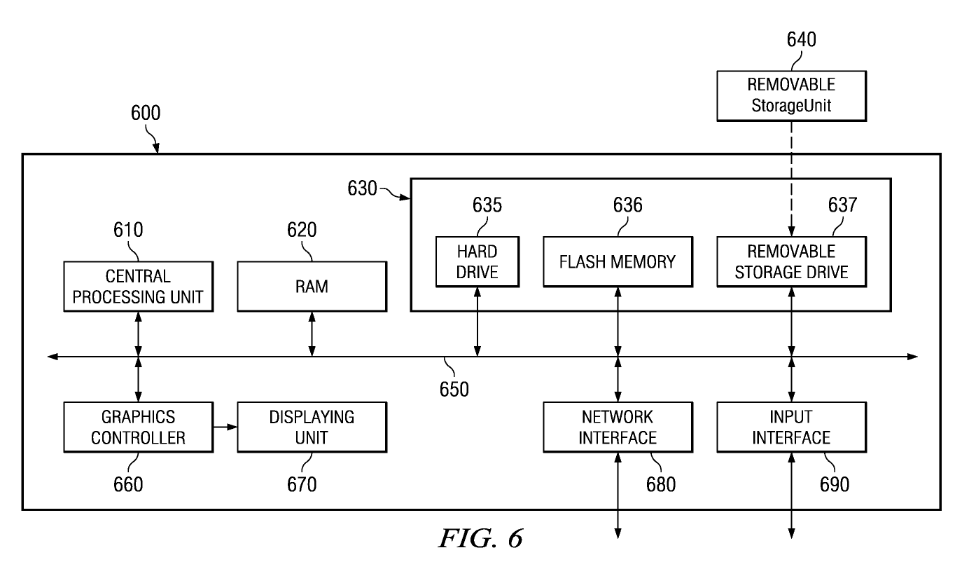

FIG. 6 is a block diagram illustrating the details of processing unit 150 in an embodiment. Processing unit 150 may contain one or more processors such as central processing unit (CPU) 610, random access memory (RAM) 620, secondary storage unit 630, display controller 660, network interface 680, and input interface 690. All the components may communicate with each other over communication path 650, which may contain several buses as is well known in the relevant arts.

CPU 610 may execute instructions stored in RAM 620 to provide several features of the present invention. CPU 610 may contain multiple execution units, with each execution unit potentially being designed for a specific task. Alternatively, CPU 610 may contain only a single general-purpose processing unit.

RAM 620 may receive instructions from secondary storage unit 630 using communication path 650. In addition, RAM 620 may store video frames received from a video signal source (130) during the processing operations noted above. Similarly, RAM 620 may be used to store processed image frames. Network interface 680 provides connectivity to a network (e.g., using Internet Protocol), and may be used to receive/transmit source/compressed/encoded/decoded video/image frames on path 135 and/or path 157 of FIG. 1.

Graphics controller 660 generates display signals (e.g., in RGB format) to display unit 670 (containing display screen on which the image frames of FIGS. 3A-31 are displayed) based on data/instructions received from CPU 610. Input interface 690 may include interfaces such as keyboard/pointing devices, and interface for receiving video frames from video signal source 130. The displayed image frames and input interface provide the basis for various user interfaces described above.

Secondary storage unit 630 may contain hard drive 635, flash memory 636, and removable storage drive 637. Some or all of the data (image frames) and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Alternatively, data and instructions may be copied to RAM 620 from which CPU 610 may read and execute the instructions using the stored data. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data.

In general, the computer (or generally, machine) readable medium refers to any medium from which processors can read and execute instructions. The medium can be randomly accessed (such as RAM 620 or flash memory 636), volatile, non-volatile, removable or non-removable, etc. While the computer readable medium is shown being provided from within processing unit 150 for illustration, it should be appreciated that the computer readable medium can be provided external to processing unit 150 as well.

In this document, the term “computer program product” is used to generally refer to removable storage unit 640 or hard disk installed in hard drive 635. These computer program products are means for providing software to CPU 610. CPU 610 may retrieve the software instructions, and execute the instructions to provide various features of the present invention described above. Groups of software instructions in any form (for example, in source/compiled/ object form or post linking in a form suitable for execution by CPU 610) are termed as code.

Several aspects of the invention are described above with reference to examples for illustration. It should be understood that numerous specific details, relationships, and methods are set forth to provide a full understanding of the invention. For example, many of the functional units described in this specification have been labeled as modules/blocks in order to more particularly emphasize their implementation independence.

A module/block may be implemented as a hardware circuit containing custom very large scale integration circuits or gate arrays, off-the-shelf semiconductors such as logic chips, transistors or other discrete components. A module/block may also be implemented in programmable hardware devices such as field programmable gate arrays, programmable array logic, programmable logic devices, or the like.

Modules/blocks may also be implemented in software for execution by various types of processors. An identified module of executable code may, for instance, contain one or more physical or logical blocks of computer instructions, which may, for instance, be organized as an object, procedure, or function. Nevertheless, the executables of an identified module need not be physically located together, but may contain disparate instructions stored in different locations which when joined logically together constitute the module/block and achieve the stated purpose for the module/block.

It may be appreciated that a module/block of executable code could be a single instruction, or many instructions and may even be distributed over several code segments, among different programs, and across several memory devices. Further, the functionality described with reference to a single module/block can be split across multiple modules/blocks or alternatively the functionality described with respect to multiple modules/blocks can be combined into a single block (or other combination of blocks) as will be apparent to a skilled practitioner based on the disclosure provided herein.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting the scope of the present invention in any way.

What is claimed is:

1. A method of processing image frames in a digital processing system, said method comprising:
receiving a sequence of image frames representing respective objects contained in a corresponding sequence of scenes; and
forming a sequence of combined frames, with each combined frame having a first portion and a second portion, said first portion representing a corresponding one of said sequence of image frames and said second portion representing a part of the same image frame.

2. The method of claim 1, wherein said digital processing system is a video camera, said method further comprising:
capturing said sequence of scenes as said sequence of image frames; and
displaying said sequence of combined frames on a display screen provided in said video camera.

3. The method of claim 2, wherein said part is specified by a user as representing the area of interest in said sequence of image frames.

4. The method of claim 3, wherein said second portion occupies more space than said first portion in each of said sequence of combined frames.

5. The method of claim 4, wherein said user indicates an object in said sequence of image frames as being of interest, wherein said method further comprises:
examining each of said sequence of image frames to determine a location of said object in each of said sequence of image frames; and
setting said part to include said location for each of the sequence of image frames such that said object is tracked in said second portion.

6. The method of claim 4, wherein said first portion is a first rectangle and said second portion is remaining portion of a display area excluding said first rectangle.

7. The method of claim 6, wherein said display screen is divided into four quadrants, wherein said part is mapped to a first quadrant contained in said four quadrants, said first portion being placed in said first quadrant such that the entire image frame is displayed in said first quadrant.

8. A method of displaying scenes represented by image frames in a display device, said method comprising:
receiving a first sequence of image frames and a second sequence of image frames, each representing respective objects contained in a corresponding sequence of scenes;
identifying a sub-area of interest in each of said second sequence of image frames; and
displaying the entire image frame of said first sequence of image frames on a display screen contained in said display device with a first resolution, and then said sub-area of each of said second sequence of image frames with a second resolution and the entire image frame of the same one of said second sequence of image frames with a third resolution on said display screen,
wherein said second resolution is more than said first resolution and said third resolution is less than said first resolution.

9. The method of claim 8, wherein said display device is a video camera, said method further comprising:
receiving a first sequence of scenes and a second sequence of scenes, each representing respective objects contained in a corresponding sequence of scenes; and
capturing said first sequence of scenes as respective ones of said first sequence of image frames and said second sequence of scenes as respective ones of said second sequence of image frames, all of said first sequence of image frames and said second sequence of image frames being mapped to a same coordinate space.

10. The method of claim 8, wherein the entire image frame of said first sequence of image frames is displayed on the entire display area available on said display screen,
wherein each of the said second sequence of image frames and the corresponding sub-image together are also displayed on said entire display area.

11. The method of claim 10, wherein said entire display area is a rectangle.

12. The method of claim 10, wherein said identifying comprises:
receiving a user selection indicating a location of interest in said second sequence of image frames based on said same coordinate space; and
including a sub-area around said location of interest as said sub-image.

13. The method of claim 12, wherein said display area contains four quadrants and said location of interest is contained in a first quadrant,
said displaying displays the entire image frame of each of said second sequence of image frames in said first quadrant.

14. The method of claim 12, wherein said user selection identifies an object in said second sequence of image frames based on said location of interest, wherein said identifying comprises:
examining each of said second sequence of image frames to determine a location of said object in each of the sequence of image frames; and
setting said part to include said location for each of the sequence of image frames such that said object is tracked in said second portion.

15. A system comprising:
a processor;
a random access memory; and
a machine readable medium storing one or more sequences of instructions, wherein execution of said one or more sequences of instructions by said processor causes said system to perform the actions of:
receiving a sequence of image frames representing respective objects contained in a corresponding sequence of scenes; and
forming a sequence of combined frames, with each combined frame having a first portion and a second portion, said first portion representing a corresponding one of said sequence of image frames and said second portion representing a portion of the same image frame.

16. The system of claim 15, wherein said system is a video camera, said system further comprising:
a video source to capture said sequence of scenes as said sequence of image frames; and
a display unit to display said sequence of combined frames.

17. The system of claim 16, wherein said second portion is specified by a user as representing the area of interest in said sequence of image frames.

18. The system of claim 17, wherein said user indicates an object in said sequence of image frames as being of interest, wherein said machine readable medium stores additional instructions for:
examining each of said sequence of image frames to determine a location of said object in each of the sequence of image frames; and
setting said part to include said location for each of the sequence of image frames such that said object is tracked in said second portion.

19. The system of claim 17, wherein said first portion is a first rectangle and said second portion is remaining portion of a display area excluding said first rectangle.

20. The system of claim 17, wherein said display screen is divided into four quadrants, wherein said part is mapped to a first quadrant contained in said four quadrants, said first portion being placed in said first quadrant such that the entire image frame is displayed in the first quadrant.
